(19) United States
(12) Patent Application Publication
(10) Pub. No.: US 2026/0161588 A1
(43) Pub. Date: Jun. 11, 2026

(54) MEMORY CONTROL METHOD AND APPARATUS FOR ACHIEVING PETAFLOPS PERFORMANCE OF ARTIFICIAL NEURAL NETWORK ACCELERATOR

(71) Applicant: Electronics and Telecommunications Research Institute, Daejeon (KR)

(72) Inventors: Yong-Cheol CHO, Daejeon (KR); Ju-Yeob KIM, Daejeon (KR); Jin-Ho HAN, Seoul (KR); Jin-Kyu KIM, Sejong-si (KR); Jae-Hoon CHUNG, Daejeon (KR); Jae-Woong CHOI, Daejeon (KR)

(73) Assignee: Electronics and Telecommunications Research Institute, Daejeon (KR)

(21) Appl. No.: 19/414,770

(22) Filed: Dec. 10, 2025

(30) Foreign Application Priority Data
Dec. 11, 2024 (KR) 10-2024-0183895
Nov. 26, 2025 (KR) 10-2025-0182216

(51) Int. Cl. G06F 13/28; G06F 9/30; G06F 13/16; G06F 17/16

(52) U.S. Cl. CPC G06F 13/28; G06F 9/30127; G06F 13/1678; G06F 17/16

(57) ABSTRACT

Disclosed herein is a memory control method and apparatus for achieving petaflops performance of an artificial neural network accelerator. The memory control method in a system, including a host processor, an artificial neural network accelerator, external memory, and a memory control device for controlling data movement between the external memory and the artificial neural network accelerator, includes generating, by the host processor, a load transaction for reading data to be used for an operation of the artificial neural network accelerator from the external memory or a store transaction for storing an operation result of the artificial neural network accelerator into the external memory; and loading or storing, by the memory control device, data from or to the external memory based on a burst scheme using a wide channel, according to the load transaction or the store transaction.

### CROSS REFERENCE TO RELATED APPLICATIONS

This application claims the benefit of Korean Patent Applications No. 10-2024-0183895, filed Dec. 11, 2024, and No. 10-2025-0182216, filed Nov. 26, 2025, which are hereby incorporated by reference in their entireties into this application.

### BACKGROUND OF THE INVENTION

### 1. Technical Field

The present disclosure relates generally to memory control technology for supporting petaflops-class performance of an artificial neural network accelerator, and more particularly to memory load/store technology that can quickly provide/store data from High Bandwidth Memory (HBM), to which advanced semiconductor heterogenous integration and state-of-the-art packaging technologies are applied, to an artificial neural network accelerator (NNA) optimized for parallel matrix operations in order to efficiently process large-scale parallel operations required by large artificial neural networks.

### 2. Description of the Related Art

The introduction of High Bandwidth Memory (HBM) technology enables high-speed memory access through wide data channels using advanced stacking and packaging technologies. Neural network models that require massive amounts of matrix operations continue to scale up rapidly, and such operations are processed by neural network accelerators (NNAs).

In a system including an NNA, a data transfer mechanism is required among components such as the NNA itself, a local cache, external memory (HBM), and a host processor (CPU). Here, the memory load/store unit may be a crucial component because the functionality and performance thereof determine how efficiently the submodules of the system are utilized.

### DOCUMENTS OF RELATED ART

(Patent Document 1) U.S. Patent Application Publication US2020/0104690, published on Apr. 2, 2020 and titled “Neural processing unit (NPU) direct memory access (NDMA) hardware pre-processing and post-processing”.

### SUMMARY OF THE INVENTION

An object of the present disclosure is to provide memory load/store technology that provides high bandwidth and wide channel memory access for an artificial neural network accelerator while supporting additional functions.

In order to accomplish the above object, a memory control method according to the present disclosure in a system including a host processor, an artificial neural network accelerator, external memory, and a memory control device for controlling data movement between the external memory and the artificial neural network accelerator includes generating, by the host processor, a load transaction for reading data to be used for an operation of the artificial neural network accelerator from the external memory or a store transaction for storing an operation result of the artificial neural network accelerator into the external memory; and loading or storing, by the memory control device, data from or to the external memory based on a burst scheme using a wide channel, according to the load transaction or the store transaction.

Here, the burst scheme using the wide channel may correspond to a scheme of transferring consecutive data blocks from the external memory in parallel through a plurality of transmission paths.

Here, when performing the load transaction, the memory control device may load data from the external memory via cache memory.

Here, the memory control device may perform matrix transpose processing on data loaded from the external memory during execution of the load transaction.

Here, the memory control device may perform data type conversion on data loaded from the external memory.

Here, the artificial neural network accelerator may include a plurality of operand register windows, and while the artificial neural network accelerator performs an operation using data stored in any one of the plurality of operand register windows, the memory control device may preload data into the remaining operand register windows that are not used for the operation.

Here, the artificial neural network accelerator may include at least three operand register windows, and the memory control device may preload data into a second operand register window and a third operand register window while a first operand register window is used for an operation.

Here, the memory control device may read an operation result from an accumulation register within the artificial neural network accelerator and store the operation result into the external memory in units of blocks according to the store transaction.

Here, the host processor may generate the load transaction or the store transaction using an instruction in which a transaction length, data type conversion information, matrix transpose information, and register selection information are configured as bit fields.

Here, the instruction may correspond to an R-TYPE format of RISC-V or a user-defined format extended therefrom.

Here, the bit fields may be encoded using a RISC-V user-defined instruction space.

Here, the bit fields may include a transaction ID, a transaction length, a register type selection, a data type conversion flag, a matrix transpose flag, and a write strobe field.

Also, a memory control system for an artificial neural network accelerator according to an embodiment of the present disclosure includes a host processor, an artificial neural network accelerator, external memory, and a memory control device for controlling data movement between the external memory and the artificial neural network accelerator. The host processor generates a load transaction for reading data to be used for an operation of the artificial neural network accelerator from the external memory or a store transaction for storing an operation result of the artificial neural network accelerator into the external memory, and the memory control device loads or stores data from or to the external memory based on a burst scheme using a wide channel, according to the load transaction or the store transaction.

Here, the burst scheme using the wide channel may correspond to a scheme of transferring consecutive data blocks from the external memory in parallel through a plurality of transmission paths.

Here, when performing the load transaction, the memory control device may load data from the external memory via cache memory.

Here, the memory control device may perform matrix transpose processing on data loaded from the external memory during execution of the load transaction.

Here, the memory control device may perform data type conversion on data loaded from the external memory.

Here, the artificial neural network accelerator may include a plurality of operand register windows, and while the artificial neural network accelerator performs an operation using data stored in any one of the plurality of operand register windows, the memory control device may preload data into the remaining operand register windows that are not used for the operation.

Here, the artificial neural network accelerator may include at least three operand register windows, and the memory control device may preload data into a second operand register window and a third operand register window while a first operand register window is used for an operation.

Here, the memory control device may read an operation result from an accumulation register within the artificial neural network accelerator and store the operation result into the external memory in units of blocks according to the store transaction.

Here, the host processor may generate the load transaction or the store transaction using an instruction in which a transaction length, data type conversion information, matrix transpose information, and register selection information are configured as bit fields.

Here, the instruction may correspond to an R-TYPE format of RISC-V or a user-defined format extended therefrom.

Here, the bit fields may be encoded using a RISC-V user-defined instruction space.

Here, the bit fields may include a transaction ID, a transaction length, a register type selection, a data type conversion flag, a matrix transpose flag, and a write strobe field.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a memory control system for an artificial neural network accelerator according to an embodiment of the present disclosure;

FIG. 2 is a flowchart illustrating a memory control method for achieving petaflops performance of an artificial neural network accelerator according to an embodiment of the present disclosure;

FIG. 3 is a view illustrating an example of an artificial neural network accelerator according to the present disclosure;

FIGS. 4 and 5 are views illustrating an example of an operand register window according to the present disclosure;

FIG. 6 is a view illustrating an example of a transmission path using a wide channel according to the present disclosure;

FIG. 7 is a view illustrating an example of bit fields of a RISC-V-based instruction according to the present disclosure;

FIG. 8 is a view illustrating an example of the configuration of bit fields for explaining an operation mode of an ANCTCA instruction according to the present disclosure;

FIG. 9 is a flowchart illustrating in detail a process of performing a load transaction in a memory control method according to the present disclosure; and

FIG. 10 is a flowchart illustrating in detail a process of performing a store transaction in a memory control method according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

An artificial neural network requires a massive amount of matrix computation. Because such matrix computations are inherently independent, they may be performed in parallel. An artificial neural network accelerator (NNA) takes advantage of this property and concurrently processes a large number of operations by using large-scale parallel hardware.

However, even if many parallel computation circuits are available, a mechanism to handle loading and storing of large-scale data required by these circuits is essential.

High Bandwidth Memory (HBM) based on the latest semiconductor packaging technology enables data access using wide data channels. Ultimately, in order for a system to achieve the maximum performance, it is necessary to fully utilize not only the computation performance of an NNA but also the wide memory bandwidth provided by HBM.

Considering these points, the present disclosure proposes memory load/store technology that provides the functionality for efficiently transferring data between an NNA and HBM.

Hereinafter, a preferred embodiment of the present disclosure will be described in detail with reference to the accompanying drawings.

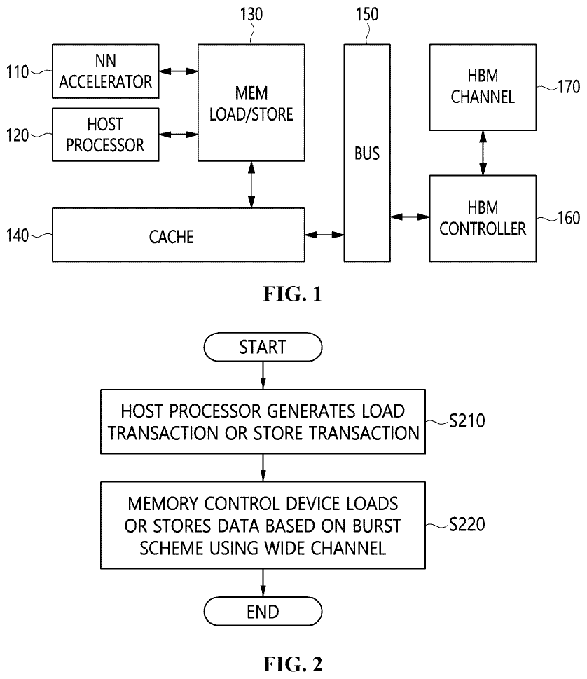

FIG. 1 is a view illustrating a memory control system for an artificial neural network accelerator according to an embodiment of the present disclosure.

Referring to FIG. 1, the memory control system for an artificial neural network accelerator according to an embodiment of the present disclosure includes an artificial neural network accelerator (NNA) 110, a host processor 120, a memory control device 130, a cache 140, a bus 150, an HBM controller 160, and HBM (external memory) 170.

Here, the memory control device 130 may control access to the cache 140, and the cache 140 may access the HBM 170 via the bus 150 when necessary.

Here, the HBM 170 corresponds to the external memory described in the present disclosure and is referred to as external memory 170 for convenience of description.

Hereinafter, the memory control method illustrated in FIG. 2 will be described in detail by applying the memory control method to the system structure illustrated in FIG. 1.

FIG. 2 is a flowchart illustrating a memory control method for achieving petaflops performance of an artificial neural network accelerator according to an embodiment of the present disclosure.

Referring to FIG. 2, in the memory control method for achieving petaflops performance of an artificial neural network accelerator according to an embodiment of the present disclosure, the host processor 120 generates a load transaction for reading the data to be used for an operation of the artificial neural network accelerator 110 from the external memory 170 or a store transaction for storing an operation result of the artificial neural network accelerator 110 into the external memory 170.

Here, the artificial neural network accelerator 110 may include a plurality of operand register windows.

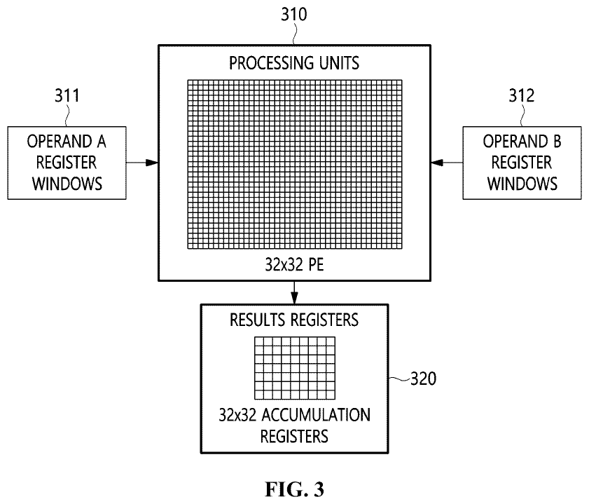

For example, referring to FIG. 3, the artificial neural network accelerator according to an embodiment of the present disclosure may include a processing unit 310 configured with a 32×32 array of Processing Elements (PEs). Here, each of the PEs may perform floating-point operations such as addition and multiplication. Also, the PEs are interconnected to enable data transfer therebetween, whereby matrix operations may be performed across the entire array dimension.

Here, each PE requires two operands, which are operand A 311 and operand B 312. That is, because the processing unit 310 includes 32×32 PEs, 32×32 operand pairs are required in order to fully utilize all of the PEs.

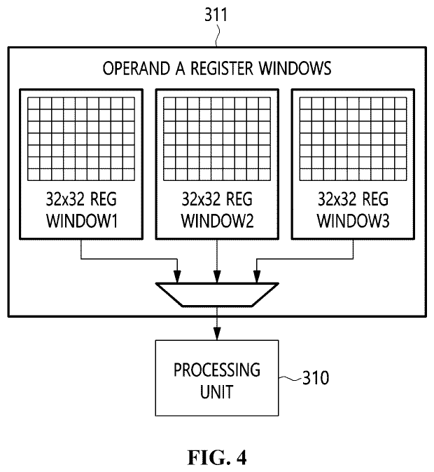

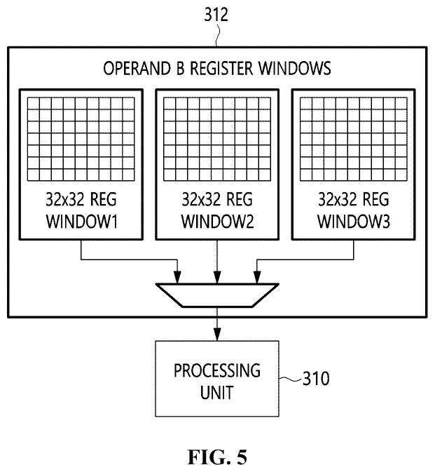

Accordingly, in order to hide load latency, the artificial neural network accelerator 110 according to the present disclosure uses three 32×32 register windows for each of operand A 311 and operand B 312. The description related to this is illustrated in FIGS. 4 and 5.

Referring to FIG. 3 again, the result of operation performed by the processing unit 310 may be stored in an accumulation register 320 and may then wait until the result is written (stored) to the external memory 170.

Also, in the memory control method for achieving petaflops performance of an artificial neural network accelerator according to an embodiment of the present disclosure, the memory control device 130 loads or stores data from or to the external memory 170 based on a burst scheme using a wide channel, according to the load transaction or the store transaction.

Here, the burst scheme using a wide channel may correspond to a scheme of transferring consecutive data blocks from the external memory 170 in parallel through a plurality of transmission paths.

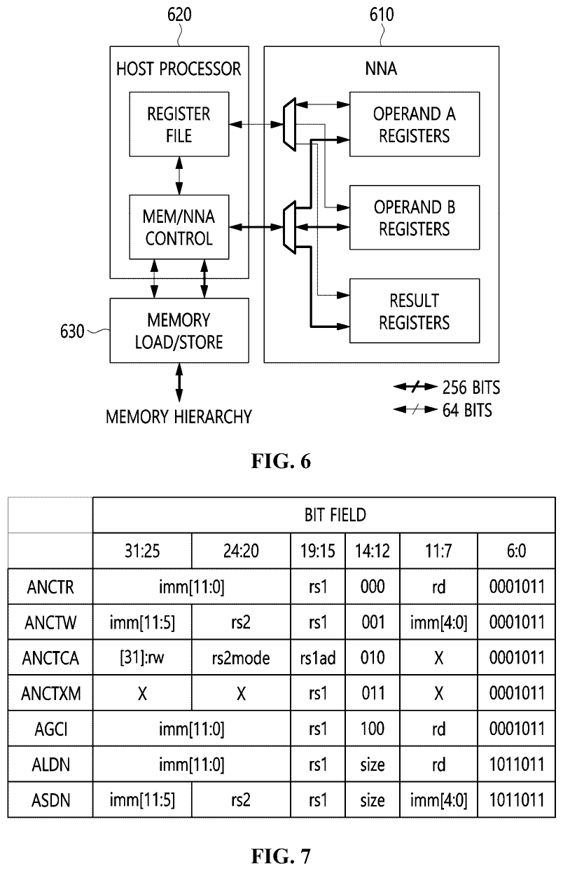

For example, FIG. 6 illustrates data paths between an artificial neural network accelerator (NNA) 610, a host processor 620, and a memory control device 630 according to the present disclosure, and it can be seen that wide channels, indicated by thick lines, and narrow channels, indicated by thin lines, are illustrated together.

Here, the narrow channels may perform the functions of a control data path or an auxiliary signaling path. That is, the wide channels may be used for transferring large-volume matrix data according to the present disclosure, and the narrow channels may perform the functions of an auxiliary path for transferring small-sized data, such as control signals or instructions.

Here, when it performs the load transaction, the memory control device 130 may load data from the external memory 170 via the cache memory 140.

For example, referring to FIG. 1, the memory control device 130 may access the cache 140 in order to load data from the external memory 170.

Here, while the artificial neural network accelerator 110 is performing an operation using the data stored in any one of the plurality of operand register windows, the memory control device 130 may preload data into the remaining operand register windows that are not being used for the operation.

Here, the memory control device 130 may preload data into the second and third operand register windows while the first operand register window is being used for the operation.

For example, while the data of window 1 illustrated in FIGS. 4 and 5 is being used for the operation of the artificial neural network accelerator 110, the remaining register windows, that is, window 2 and window 3, may perform preloading of data from the external memory 170.

Here, the memory control device 130 may read the operation result from the accumulation register within the artificial neural network accelerator 110 and store the same to the external memory 170 in units of blocks according to the store transaction.

Here, the memory control device 130 may perform matrix transpose processing on the data loaded from the external memory 170 during execution of the load transaction.

Here, the memory control device 130 may perform data type conversion on the data loaded from the external memory 170.

Here, the host processor 120 may generate the load transaction or the store transaction using an instruction in which a transaction length, data type conversion information, matrix transpose information, and register selection information are configured as bit fields.

For example, the function of data transfer between the host processor 120 and the artificial neural network accelerator 110, the function of high-speed burst data transfer based on a wide channel between the artificial neural network accelerator 110 and the cache 140, the matrix transpose function during data transfer, the data type conversion function during data transfer, and the like according to the present disclosure may be controlled through the custom instructions illustrated in Table 1.

TABLE 1

| Instruction | Description |
|---|---|
| ANCTR | Read data from a designated NNA register and store it in a |
| | designated host processor register. |
| ANCTW | Read data from a designated host processor register and |
| | write it into a designated NNA register. |
| ANCTCA | Read data from cache or external memory and write it into |
| | an NNA register, or store data from an NNA register into |
| | cache/external memory. Include burst and matrix transpose |
| | functions. |
| ANCTXM | Wait until an NNA completes the current operation. |
| AGCI | Read an NNA ID. |
| ALDNx* | Read data from memory and load it into a host processor |
| | register. The size of the data to be read is variable. |
| ASDNx* | Store data from a host processor register into memory. |
| | The size of the data to be stored is variable. |

Here, the instruction may correspond to the R-TYPE format of RISC-V or a user-defined format extended therefrom.

Here, the bit fields may be encoded using a RISC-V user-defined instruction space.

For example, FIG. 7 is a view illustrating the configuration of bit fields of RISC-V-based custom instructions for NNA control according to an embodiment of the present disclosure.

Here, each instruction has a length of 32 bits. Here, bits [6:0] correspond to the opcode field, bits [11:7] correspond to the destination register (rd) field, bits [14:12] correspond to the function code (func3) field, bits [19:15] correspond to the first source register (rs1) field, bits [24:20] correspond to the second source register (rs2) or mode field, and bits [31:25] are used as the upper bits of a constant or immediate value (imm).

Here, different instructions, such as ANCTR, ANCTW, ANCTCA, ANCTXM, AGCI, ALDN, and ASDN shown in Tablel, may be distinguished based on the combination of the function code (func3) and the opcode. Hereinafter, the configuration of the bit fields of each instruction will be described in detail with reference to FIG. 7.

The ANCTR instruction is an instruction that reads data from a designated NNA register and stores the data in a designated host processor register, and the bit fields of the ANCTR instruction may be configured as follows.

Bits [31:20] are used as the upper bits of the immediate value (imm [11:0]) and form a 12-bit immediate value including an NNA register index or additional control information.

The rs1 field in bits [19:15] designates the first source register to be used by the processor when accessing the NNA.

Bits [14:12] correspond to the function code (funct3), which is fixed to 000, and are used as an identifier for distinguishing the ANCTR instruction from other instructions with the same opcode.

The rd field in bits [11:7] designates the destination register of the host processor in which the data read from the NNA is to be stored.

Bits [6:0] correspond to a custom opcode fixed to 0001011, which represents the instruction set for NNA control according to the present disclosure.

The ANCTW instruction is an instruction that reads data from a designated host processor register and writes the data into a designated NNA register, and the bit fields of the ANCTW instruction may be configured as follows.

Bits [31:25] are used as the upper 7 bits of an immediate value imm [11:5].

The rs2 field in bits [24:20] may be used as a field that designates a register index to be referenced by the NNA or an additional source register.

The rs1 field in bits [19:15] designates the source register of the host processor that provides data.

Bits [14:12] correspond to the function code fixed to 001, which identifies the ANCTW instruction, distinguishing it from ANCTR (000) and ANCTCA (010).

Bits [11:7] are used as the lower 5 bits of imm [4:0] and form a 12-bit immediate value along with the upper bits. This immediate value may be used as an NNA register index, an offset, or a control parameter.

Bits [6:0] correspond to the opcode 0001011, which indicates that ANCTW belongs to the same instruction group as ANCTR.

The ANCTCA instruction is an instruction that transfers data bidirectionally between the cache/external memory and the NNA register, and may include burst transfer and matrix transpose functions. The bit fields of the ANCTCA instruction may be configured as follows.

Bit [31] is used as an rw bit and may be used as a flag that indicates whether the instruction corresponds to a read operation or a write operation. Bits [30:25] may be a reserved field or may be used for future extension.

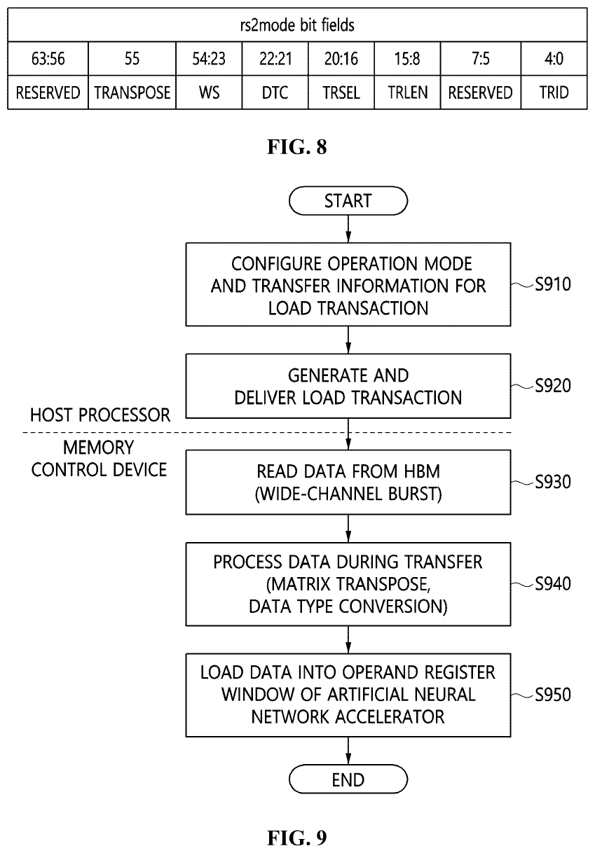

The rs2mode field in bits [24:20] represents the index of the register that specifies a transaction operation mode. This register stores bit fields, such as trid, trlen, trsel, dtc, ws, and transpose, as described in FIG. 8.

The rs1ad field in bits [19:15] designates the start address (base address) of data transfer or a register that stores the address, thereby indicating the location of the memory block to be transferred.

Bits [14:12] correspond to the function code fixed to 010, which identifies the ANCTCA instruction, distinguishing it from ANCTR/ANCTW/ANCTXM.

Bits [11:7] may be reserved depending on the implementation or may be used as an auxiliary control field in specific implementations.

Bits [6:0] correspond to the opcode 0001011, which represents that the instruction belongs to the custom instruction group for NNA control.

The ANCTXM instruction is a synchronization instruction that causes the host processor to wait until the NNA completes the current task, and the bit fields of the ANCTXM instruction may be configured as follows.

Bits [31:25] and bits [24:20] are unused fields, and, as indicated by ‘X’, they may be fixed to 0 or used as reserved fields depending on the implementation.

The rs1 field in bits [19:15] may designate a register for referencing the NNA or task status information.

Bits [14:12] correspond to the function code fixed to 011, which identifies the ANCTXM instruction, distinguishing it from ANCTCA (010) and AGCI (100).

Bits [11:7] are an unused field and may be reserved or set to 0.

Bits [6:0] use the same opcode 0001011 as the preceding instructions.

The AGCI instruction is an instruction that reads the NNA ID, and the bit fields of the AGCI instruction may be configured as follows.

Bits [31:20] are used as the upper bits of imm [11:0] and may include an additional argument or control flag to be used for retrieval of the NNA ID.

The rs1 field in bits [19:15] may designate a register that stores parameters related to the NNA ID read operation.

Bits [14:12] correspond to the function code fixed to 100, which distinguishes the AGCI instruction from other instructions.

The rd field in bits [11:7] designates the destination register of the host processor in which the read NNA ID is to be stored.

Bits [6:0] use the same opcode 0001011.

The ALDN instruction is an instruction that reads data from memory and load the data into a host processor register, and the data size is variable. The bit fields of the ALDN instruction may be configured as follows.

Bits [31:20] correspond to the upper bits of imm [11:0] and form an immediate value that includes the address offset of the data to be loaded from memory or control information.

The rs1 field in bits [19:15] designates a register that stores the base address, and may be used to calculate the actual memory address by being combined with imm [11:0].

The size field in bits [14:12] is a field for encoding the size of the data to be loaded (e.g., 8 bits, 16 bits, 32 bits, or 64 bits).

The rd field in bits [11:7] designates the destination register of the host processor in which the loaded data is to be stored.

Bits [6:0] use the opcode 1011011, which indicates that the instruction belongs to the ALDN/ASDN instruction group, unlike the NNA control instructions.

The ASDN instruction is an instruction that stores data from a host processor register into memory, and the data size is variable. The bit fields of the ASDN instruction may be defined as follows.

Bits [31:25] are used as the upper bits of imm [11:5].

The rs2 field in bits [24:20] designates the source register that stores the data to be stored into memory or additional control information.

The rs1 field in bits [19:15] designates the register that stores a base address, and this field is combined with imm [11:0] to determine the actual memory address at which the data is to be stored.

The size field in bits [14:12] encodes the size of the data to be stored, and it may be interpreted in the same manner as in the ALDN instruction.

Bits [11:7] are used as the lower bits of imm [4:0] and form a 12-bit immediate value along with the upper bits.

Bits [6:0] use the opcode 1011011, which indicates that the instruction belongs to the same instruction group as ALDN.

Here, the bit fields may include a transaction ID, a transaction length, a register type selection, a data type conversion flag, a matrix transpose flag, and a write strobe field.

For example, FIG. 8 illustrates bit fields for setting the operation mode of the ANCTCA instruction in Table 1, and these bit fields may be included in the register designated by rs2mode. Referring to FIG. 8, trid indicates the transaction ID, trlen indicates the transfer length starting from rs1ad [47:0], trsel indicates the register type selection, dtc indicates the data type conversion option, ws indicates the write strobe, and transpose may indicate whether matrix transpose is performed on the data read from memory.

Through the above-described memory control method, the performance of a neural network with a large-scale parallel structure may be maximized.

Also, an interface function for connecting wide-channel memory, such as HBM, with an artificial neural network accelerator, such as an NPU, may be provided to enable the system to achieve the maximum performance.

FIG. 9 is a flowchart illustrating in detail a process of performing a load transaction in a memory control method according to the present disclosure.

Referring to FIG. 9, in the process of performing a load transaction in the memory control method according to the present disclosure, first, a host processor may configure the operation mode and the transfer mode (the bit field values included in the rs2mode register of the instruction) at step S910 in order to initialize the load transaction.

Here, the configured operation mode and transfer mode may subsequently be used to control the overall process of loading data by a memory control device.

Then, when the configuration is completed, the host processor may generate and transfer a load transaction at step S920.

For example, an ANCTCA instruction, including the start address of the load transaction (rs1ad) and the mode information set in rs2mode, may be generated, and the generated instruction may be transferred to the memory control device.

Subsequently, based on the transferred load transaction, the memory control device may access HBM and read data at step S930.

Here, consecutive data blocks may be quickly transferred in parallel by applying a burst transfer method using wide channels. This process enables the high-performance operation of the NNA that requires large-scale matrix data.

Subsequently, the memory control device may process the data read from the HBM during the transfer process such that it matches the operation characteristics of the NNA at step S940.

For example, when the transpose bit of the transaction mode is enabled, the memory control device may transpose and transform the data to match the internal layout of the NNA before transferring the data.

In another example, when the dtc bit is enabled, the memory control device may convert the data into the data format required for the NNA operation.

Subsequently, the memory control device may store the processed data into the load target window that is not currently used for an operation, among a plurality of operand register windows within the NNA, at step S950.

When all data is loaded into the operand window, the memory control device completes the load procedure, and the NNA may immediately perform a subsequent operation.

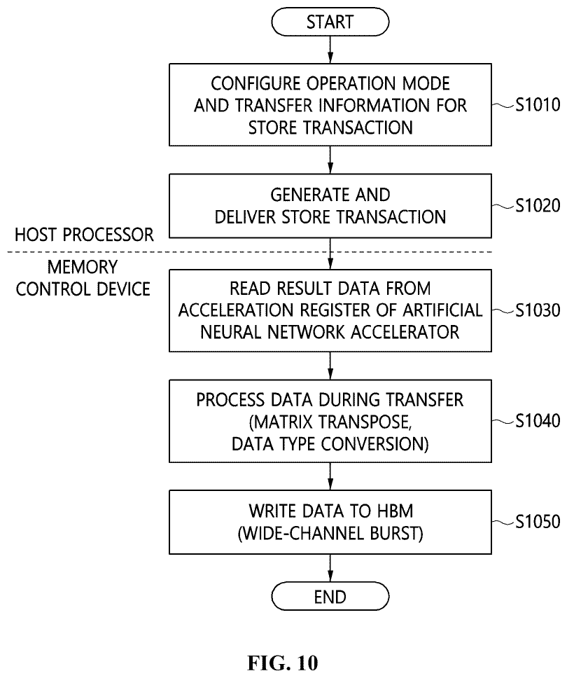

FIG. 10 is a flowchart illustrating in detail a process of performing a store transaction in a memory control method according to the present disclosure.

Referring to FIG. 10, in the process of performing a store transaction in the memory control method according to the present disclosure, first, a host processor may configure the operation mode and transfer information for the store transaction to be performed to store an operation result output by an NNA into external memory at step S1010.

Here, the mode register (rs2mode), which includes bit fields, such as a transaction ID, a transfer length, a register type, data type conversion information, matrix transpose information, a write strobe, and the like, may be configured. The configured mode information may define the detailed store operations to be subsequently performed by the memory control device.

Subsequently, the host processor may generate and transfer a store transaction at step S1020.

For example, an ANCTCA instruction, including the configured rs2mode and the address information (rs1) of an accumulation register or result buffer storing the NNA operation result, is generated, and the generated instruction may be transferred to the memory control device.

Subsequently, the memory control device may read the operation result data from the accumulation register within the NNA in units of blocks based on the transferred store transaction at step S1030.

Here, the NNA may perform operations through a plurality of operand windows, and because the result of the completed operation is stored in the accumulation register, only the required result data block may be selectively read according to the set transfer length (trlen).

Subsequently, the memory control device may process the result data read from the NNA at step S1040 before storing the result data into the external memory.

For example, when the transpose bit of the mode bits of the store transaction is enabled, the memory control device may perform a matrix transpose operation that swaps rows and columns to convert the result data stored in the format of the NNA into a format suitable for storage in HBM.

In another example, when the dtc bit is enabled, the memory control device may convert the representation format of the data. That is, the internal operation is performed in FP32, but the data may be converted into a lower-precision format, such as FP16, BP16, INT8, or the like, before storage in HBM.

All of these processing steps may be automatically performed according to the configuration of the bit fields included in rs2mode, and enable flexible separation between the internal operation format of the NNA and the external memory storage format.

Subsequently, the memory control device may write (store) the processed result data into the external memory based on a burst transfer method using wide channels at step S1050.

Here, consecutive result data blocks may be transferred in parallel through a plurality of transmission paths, and the wide channel width of the HBM interface may be utilized to store large amounts of result data at high speed.

When all the result data is successfully stored in the external memory, the memory control device may update the completion status of the store transaction in the internal status register or may notify the host processor through an interrupt or status flag if necessary. Accordingly, the host processor may schedule subsequent operation tasks or utilize the stored result data for post-processing based on such information.

According to the present disclosure, high-speed load/store processing based on burst transfer using a wide channel is performed, whereby the performance of a neural network having a large-scale parallel structure may be maximized.

Also, the present disclosure provides an interface function that connects memory having a wide channel width, such as HBM, with an artificial neural network accelerator, such as an NPU, thereby supporting a system to achieve the maximum performance.

Also, the present disclosure may make it possible for an NPU to reach petaflops-level performance without bottlenecks.

As described above, the memory control method and apparatus for achieving petaflops performance of an artificial neural network accelerator according to the present disclosure are not limitedly applied to the configurations and operations of the above-described embodiments, but all or some of the embodiments may be selectively combined and configured, so the embodiments may be modified in various ways.

What is claimed is:

1. A memory control method in a system including a host processor, an artificial neural network accelerator, external memory, and a memory control device for controlling data movement between the external memory and the artificial neural network accelerator, the memory control method comprising:
generating, by the host processor, a load transaction for reading data to be used for an operation of the artificial neural network accelerator from the external memory or a store transaction for storing an operation result of the artificial neural network accelerator into the external memory; and
loading or storing, by the memory control device, data from or to the external memory based on a burst scheme using a wide channel, according to the load transaction or the store transaction.

2. The memory control method of claim 1, wherein the burst scheme using the wide channel corresponds to a scheme of transferring consecutive data blocks from the external memory in parallel through a plurality of transmission paths.

3. The memory control method of claim 1, wherein, when performing the load transaction, the memory control device loads data from the external memory via cache memory.

4. The memory control method of claim 3, wherein the memory control device performs matrix transpose processing on data loaded from the external memory during execution of the load transaction.

5. The memory control method of claim 3, wherein the memory control device performs data type conversion on data loaded from the external memory.

6. The memory control method of claim 1, wherein
the artificial neural network accelerator includes a plurality of operand register windows, and
while the artificial neural network accelerator performs an operation using data stored in any one of the plurality of operand register windows, the memory control device preloads data into remaining operand register windows that are not used for the operation.

7. The memory control method of claim 6, wherein
the artificial neural network accelerator includes at least three operand register windows, and
the memory control device preloads data into a second operand register window and a third operand register window while a first operand register window is used for an operation.

8. The memory control method of claim 1, wherein the memory control device reads an operation result from an accumulation register within the artificial neural network accelerator and stores the operation result into the external memory in units of blocks according to the store transaction.

9. The memory control method of claim 1, wherein the host processor generates the load transaction or the store transaction using an instruction in which a transaction length, data type conversion information, matrix transpose information, and register selection information are configured as bit fields.

10. The memory control method of claim 9, wherein the instruction corresponds to an R-TYPE format of RISC-V or a user-defined format extended therefrom.

11. The memory control method of claim 10, wherein the bit fields are encoded using a RISC-V user-defined instruction space.

12. The memory control method of claim 11, wherein the bit fields include a transaction ID, a transaction length, a register type selection, a data type conversion flag, a matrix transpose flag, and a write strobe field.

13. A memory control system for an artificial neural network accelerator, comprising:
a host processor;
an artificial neural network accelerator;
external memory; and
a memory control device for controlling data movement between the external memory and the artificial neural network accelerator,
wherein
the host processor generates a load transaction for reading data to be used for an operation of the artificial neural network accelerator from the external memory or a store transaction for storing an operation result of the artificial neural network accelerator into the external memory, and
the memory control device loads or stores data from or to the external memory based on a burst scheme using a wide channel, according to the load transaction or the store transaction.

14. The memory control system of claim 13, wherein the burst scheme using the wide channel corresponds to a scheme of transferring consecutive data blocks from the external memory in parallel through a plurality of transmission paths.

15. The memory control system of claim 13, wherein, when performing the load transaction, the memory control device loads data from the external memory via cache memory.

16. The memory control system of claim 15, wherein the memory control device performs matrix transpose processing on data loaded from the external memory during execution of the load transaction.

17. The memory control system of claim 15, wherein the memory control device performs data type conversion on data loaded from the external memory.

18. The memory control system of claim 13, wherein
the artificial neural network accelerator includes a plurality of operand register windows, and
while the artificial neural network accelerator performs an operation using data stored in any one of the plurality of operand register windows, the memory control device preloads data into remaining operand register windows that are not used for the operation.

19. The memory control system of claim 18, wherein
the artificial neural network accelerator includes at least three operand register windows, and
the memory control device preloads data into a second operand register window and a third operand register window while a first operand register window is used for an operation.

20. The memory control system of claim 13, wherein the memory control device reads an operation result from an accumulation register within the artificial neural network accelerator and stores the operation result into the external memory in units of blocks according to the store transaction.
